(19) United States
(12) Patent Application Publication
(10) Pub. No.: US 2006/0131887 A1
(43) Pub. Date: Jun. 22, 2006

(54) Magnetically actuated reciprocating motor and process using reverse magnetic switching

(76) Inventor: Kendall C. Gosvener, Porterville, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/356,372

(22) Filed: Feb. 15, 2006

Related U.S. Application Data
(63) Continuation-in-part of application No. 10/441,048, filed on May 20, 2003, now abandoned.
(60) Provisional application No. 60/382,624, filed on May 24, 2002.

(51) Int. Cl. F03G 7/08

(52) U.S. Cl. 290/1 R

(57) ABSTRACT

A magnetically actuated reciprocating motor utilizes the stored energy of magnets, particularly rare earth magnets, to reciprocally drive a piston in a cylinder chamber. The piston connects to a converting mechanism, such as a crankshaft having a first and second output shaft, to convert the reciprocating motion of the piston to rotary motion for powering a work object at the second output shaft. The first output shaft operatively connects to and rotatably drives a controlling mechanism, which attaches to a magnetic switching device having a magnetic fixture comprising one or more magnets that magnetically engage a piston magnet associated with the piston. In response to the operation of the controlling mechanism, the magnetic switching device pivots or rotates the magnetic fixture to change the polarity directed at the piston magnet in order to attract or repel the piston, rotate the crankshaft and operate the controlling mechanism.

### CROSS-REFERENCE TO RELATED APPLICATIONS

This application is a continuation-in-part of copending U.S. patent application Ser. No. 10/441,048 filed May 20, 2003, now abandoned, which claimed the benefit of U.S. Provisional Patent Application No. 60/382,624 filed May 24, 2002.

### BACKGROUND OF THE INVENTION

A. Field of the Invention

The field of the present invention relates generally to reciprocating motors which utilize a piston drive mechanism to provide power to an output shaft or crankshaft. More particularly, the present invention relates to such motors in which the magnetic repelling and attracting forces of permanent magnets are utilized to reciprocate the piston. Even more particularly the present invention relates to such motors in which the change in direction of the piston is obtained by pivoting the magnets to alternatively repel or attract the piston.

B. Background

Reciprocating motors have been and continue to be used in virtually every available mode of transportation and for all types of power supply needs throughout the entire world. Generally, reciprocating motors have a piston slidably disposed in a cylinder and utilize a driving force to drive the piston in one or both directions inside the cylinder so as to rotate an output shaft, such as a crankshaft. The most commonly utilized reciprocating motor is an internal combustion engine. The typical internal combustion engine comprises a series of cylinders each having a piston reciprocating inside to drive a crankshaft in order to produce motion or power. Air and fuel are combined in the piston chamber, defined inside the cylinder by the top of the piston, and ignited by a spark from a spark plug to provide an explosive driving force that drives the piston downward. The fuel and air are fed into the piston chamber through an intake valve and, after combustion, exhaust air is forced out through an exhaust valve. To obtain proper performance of the fuel/air igniting sequence, the valve activating mechanism must open and close the intake and exhaust valves at the proper times. Due to relatively high engine operating speeds, this process happens at a very fast rate. Due to their extensive use, the internal combustion engine has been the subject of intensive efforts in the United States and most industrialized countries since the beginning of their utilization to improve the engine's operating characteristics. Despite these efforts, internal combustion engines are well known for relatively inefficient utilization of fuel, such as gasoline and other products made from oil, and being significant contributors to the air pollution problems that exist in most cities and towns. As such, the continued use of internal combustion engines is recognized by many persons as a significant draw on the Earth's limited natural resources and a substantial threat to human health.

Other types of reciprocating devices are also well known. For instance, electromagnetic reciprocating engines utilize electromagnetic force as the driving force to move the piston inside the cylinder and rotate the output shaft. A typical configuration for such engines comprises a plurality of electrical coils disposed around the cylinder that are actuated by electrical currents to provide the electromagnetic force necessary to drive the piston in a reciprocating motion in the cylinder. It is well known that this type of electromagnetic engine must have a somewhat large supply of electrical current to power the coils and typically requires a complex control mechanism to provide the electrical current to the coils in a manner so as to operate the engine. For these and other practical reasons, electromagnetic reciprocating engines have generally not become very well accepted.

Another source of power that has been utilized to reciprocate a piston inside a cylinder is the magnetic energy stored in permanent magnets. As is well known, when the same polarity ends of two magnets are placed near each other the repulsion force of the two magnetic fields will repel the magnets and, conversely, when the opposite polarity ends of two magnets are placed near each other the attraction force of the magnetic fields will attract the magnets toward each other, assuming one or both of the magnets are allowed to move. A known advantage of utilizing permanent magnets as the driving force for a reciprocating motor is that the energy available from these magnets is relatively constant and capable of providing a long operating life. In order to use permanent magnets to reciprocally drive a piston inside a cylinder, however, a mechanism must be provided that first utilizes the advantage of dissimilar polarity to attract the piston to the permanent magnet and then utilize the advantage of similar polarity to drive the piston away from the permanent magnet. Naturally, this must be done in a very rapid manner at the proper time. The difficulties with being able to rapidly switch polarity when using permanent magnets, as opposed to electromagnetic force, has heretofore substantially limited the ability to utilize the advantages of permanent magnets as a driving force to reciprocate a piston in a cylinder so as to rotate an output shaft for the purposes of motion or the generation of electricity.

Over the years, various reciprocating devices that utilize permanent magnets as the driving force to reciprocate a piston, to one extent or another, have been patented. For instance, U.S. Pat. No. 3,811,058 to Kiniski discloses a reciprocating device comprising an open-bottomed cylinder having a piston made out of magnetic material, with a predetermined polarity, slidably disposed in the cylinder chamber. A disc rotatably mounted to the engine block below the cylinder has at least one permanent magnet, of like polarity, on the surface facing the open bottom of the cylinder such that the rotation of the disc periodically aligns the permanent magnet with the piston so the repulsive force therebetween causes the piston to reciprocate in the cylinder chamber. U.S. Pat. No. 3,967,146 to Howard discloses a magnetic motion conversion motor having permanent magnets arranged with like poles facing each other and a magnetic flux field suppressor disposed between the magnets for repeatedly causing a magnetic repelling and attracting action as it is moved into alignment between the like poles of the magnets. The magnets reciprocally drive piston rods connected to crankshafts that are connected to a common drive shaft, as the main output shaft for the motor. U.S. Pat. No. 4,317,058 to Blalock discloses an electromagnetic reciprocating engine having a nonferromagnetic cylinder with a permanent magnetic piston reciprocally disposed therein and an electromagnet disposed at the outer end of the cylinder. A switching device, interconnecting the electromagnet to an electrical power source, causes the electromagnet to create an electrical field that reciprocates the piston within the cylinder. U.S. Pat. No. 4,507,579 to Turner discloses a reciprocating piston electric motor having a magnetic piston slidably disposed in a nonmagnetic cylinder that has wire coils wrapped around the ends thereof that are electrically activated to reciprocate the piston inside the cylinder to drive a crankshaft connected to the piston by a piston rod. U.S. Pat. No. 5,457,349 to Gifford discloses a reciprocating electro-magnetic engine having fixed magnets mounted in the piston that intermittently attract and repel sequentially energized electromagnets that are radially mounted in the cylinder walls. A computerized control mechanism regulates the timing of the electromagnets to reciprocate the piston and drive a rotatable crankshaft. U.S. Pat. No. 6,552,450 to Harty, et al. discloses a reciprocating engine having a piston reciprocally disposed in a cylinder that is driven by opposing electromagnets connected with the piston and cylinder. A polarity switching mechanism switches polarity to reciprocate the piston.

One of the major disadvantages associated with previously disclosed or presently available permanent magnet reciprocating motors is that mechanism for switching polarity to reciprocally drive the piston in the cylinder requires an external power source to effect the polarity change, so as to cause the attraction and repulsion forces, necessary to reciprocate the piston. The most common method of switching polarity is the use of electromagnets, which require a switching mechanism interconnecting a power source with the electromagnets. Other devices utilize an electric motor or other prime mover to rotate or pivot a member having the permanent magnets so as to periodically attract or repel magnets on the piston to provide the force necessary for reciprocating the piston. Naturally, the use of an external power source or prime mover substantially reduces the energy efficiency of the magnetically actuated reciprocating motor and, therefore, one of the primary benefits of such motors. Another major disadvantage that is associated with presently available magnetically actuated reciprocating motors is that the switching mechanisms are generally somewhat complicated and subject to malfunction or cessation of operation, due in part to the need for the external power source or prime mover.

What is needed, therefore, is an improved magnetically actuated reciprocating motor that has an improved mechanism for switching polarities so as to periodically attract and repel a piston reciprocally disposed in a cylinder. Preferably, the improved reciprocating motor does not rely on an external source of power or prime mover to move permanent magnets from an attracting position to a repelling position so as to reciprocally drive a piston disposed in a cylinder. The preferred reciprocating motor will be relatively simple to operate, require a limited number of moving components and be relatively inexpensive to manufacture. The preferred reciprocating motor should connect to a crankshaft to produce rotary power and be adaptable to a wide variety of reciprocating motor uses, including vehicle motion and power generation.

### SUMMARY OF THE INVENTION

The magnetically actuated reciprocating motor of the present invention solves the problems and provides the benefits identified above. That is to say, the present invention discloses a new and improved reciprocating motor that utilizes a switching mechanism which is operated by the motor to provide the reverse magnetic switching necessary to effectuate the reciprocation of a piston inside a cylinder. The switching mechanism rapidly pivots permanent magnets to alternately direct the magnetic polarity of the permanent magnets toward a magnet associated with the piston in a manner that reciprocates the piston inside the cylinder. The new magnetically actuated reciprocating motor does not rely on an external source of power or a prime mover to pivot, rotate or otherwise move the permanent magnets from an attracting position to a repelling position in order to reciprocally drive the piston inside the cylinder. The new reciprocating motor is relatively simple to operate, requires a limited number of moving components and is relatively inexpensive to manufacture. The magnetically actuated reciprocating motor of the present invention connects to a crankshaft so as to produce rotary power that is adaptable to a wide variety of reciprocating motor uses, including vehicle motion and power generation.

In one general aspect of the present invention, the magnetically actuated reciprocating motor comprises a cylinder having a first end and a second end that defines a chamber therein which reciprocally receives a piston having a first end generally disposed toward the first end of the cylinder and a second end generally disposed toward the second end of the cylinder. The cylinder should be made from a nonferromagnetic material to avoid interference with the magnetic forces of the present motor. The piston has a piston magnet with a piston magnet polarity that is directed outward of the first end of the piston toward the first end of the cylinder. Although the piston itself can be the piston magnet, in the preferred embodiment the piston magnet is fixed attached to or integral with the first end of the piston, which should also be made from a nonferromagnetic material. The motor is provided with a mechanism for converting the reciprocating movement of the piston to rotate a work object and a first output shaft. In the preferred embodiment, this mechanism comprises a connecting rod that interconnects the piston and a crankshaft, which has the first output shaft at one end and a second output shaft at the opposite end. The second output shaft is configured to rotate the work object, such as a flywheel. To effectuate the magnetic polar switching necessary to achieve reciprocation of the piston, the motor has a magnetic switching device that has a magnetic fixture disposed above the first end of the cylinder that is configured to magnetically interact with the piston magnet. In the preferred embodiment, the magnetic fixture is attached to a magnetic fixture shaft that is rotatably supported above the first end of the cylinder by a support structure. The magnetic fixture has one or more fixture magnets, a first fixture polarity and a second fixture polarity. The first fixture polarity corresponds to the piston magnet polarity and the second fixture polarity is opposite the piston magnet polarity.

The motor also includes a kinetic energy storage device that comprises a mechanism for interconnecting the first output shaft with the magnetic fixture of the magnetic switching device so as to control the rotational movement of the magnetic fixture in a manner that reciprocates the piston in the chamber. In one embodiment, the controlling mechanism comprises a belt member interconnecting a first pulley that is attached to the first output shaft and a second pulley that is attached to the magnetic switching device so as to effectuate the switching of polarity between the first fixture polarity and the second fixture polarity necessary to reciprocate the piston. Instead of a belt interconnecting the two pulleys, a chain-drive system or a series of gears can be utilized to transfer the rotation of the first output shaft to the magnetic switching device. A spring operated or hydraulic fluid mechanism can alternatively be utilized as the controlling mechanism. During operation of the reciprocating motor, the piston moves toward the second end of the cylinder when the first fixture polarity, the like polarity, of the fixture magnets is disposed toward the piston magnet and moves toward the first end of the cylinder when the second fixture polarity, the opposite polarity, of the fixture magnets is disposed toward the piston magnet. This reciprocating motion of the piston rotates the first output shaft and the work object.

In one preferred embodiment, the magnetic fixture has a first fixture magnet and a second fixture magnet, wherein the first fixture magnet has the first fixture polarity disposed outward from the magnetic fixture and the second fixture magnet has the second fixture polarity disposed outward from the magnetic fixture. The controlling mechanism, connected to and driven by the rotation of the first output shaft, is adapted to periodically pivot the magnetic fixture between the first fixture magnet and the second fixture magnet to alternatively direct the first fixture polarity and the second fixture polarity toward the piston magnet so as to periodically repel and attract the piston magnet and reciprocate the piston. In another preferred embodiment, the magnetic fixture comprises a first fixture magnet, a second fixture magnet, a third fixture magnet and a fourth fixture magnet. In this configuration, each of the first fixture magnet and the third fixture magnet has the first fixture polarity disposed outward from the magnetic fixture and each of the second fixture magnet and the fourth fixture magnet has the second fixture polarity disposed outward from the magnetic fixture. The controlling means is adapted to rotate the magnetic fixture, as opposed to pivoting it, so as to periodically direct the first fixture polarity and the second fixture polarity toward the piston magnet in order to periodically repel and attract the piston magnet and reciprocate the piston.

In operation, the periodic directing of the first fixture polarity and the second fixture polarity elements of the magnetic switching device towards the piston magnet at the first end of the piston will periodically repel and attract the piston so as to reciprocate it inside the cylinder. The reciprocation of the piston will, via the connecting rod, rotatably drive the crankshaft, which rotatably engages the controlling mechanism at the first output shaft of the crankshaft and rotates a work object at the second output shaft of the crankshaft. The operation of the controlling mechanism is directed to controlling the movement of the magnetic switching device so as to provide the motion and timing necessary to obtain the polarity shifting that results in reciprocation of the piston. As such, the magnetically actuated reciprocating motor of the present invention does not require any external power source or prime mover to provide the necessary polarity shifting for reciprocation of the piston, thereby making the present motor more efficient and useful for obtaining a work output, such as to operate a pump, generator or vehicle. Use of the reciprocating motor of the present invention will eliminate the energy demands and pollution associated with presently available reciprocating motors.

Accordingly, the primary objective of the present invention is to provide a magnetically actuated reciprocating motor using reverse magnetic switching that provides the advantages discussed above and overcomes the disadvantages and limitations associated with presently available magnetically powered reciprocating motors.

It is also an object of the present invention to provide a magnetically actuated reciprocating motor that does not require utilization of an external source of power or a prime mover to provide the magnetic switching necessary to magnetically reciprocate a piston inside a cylinder.

It is also an object of the present invention to provide a magnetically actuated reciprocating motor that utilizes a portion of the reciprocating motion generated by the reciprocating motor to power or otherwise drive a reverse magnetic switching mechanism configured to rapidly pivot or rotate one or more permanent magnets, cooperatively engaged with the a piston disposed inside a cylinder, so as to magnetically reciprocate the piston.

It is also an object of the present invention to provide a magnetically actuated reciprocating motor having a piston reciprocally disposed inside a cylinder with a permanent magnet associated with the top of the piston and a connecting rod attached to the bottom thereof to rotate a crankshaft that drives a belt and pulley system which rotates a reverse magnetic switching mechanism, having one or more permanent magnets so as to reciprocate the piston inside the cylinder.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is side view of a magnetically actuated reciprocating motor configured according to a preferred embodiment of the present invention particularly showing the cylinder and the pulley system;

FIG. 2 is a cross-sectional front view of the magnetically actuated reciprocating motor of FIG. 1 taken through line 2-2 of FIG. 1 showing the piston inside the cylinder, the reverse magnetic switching device positioned above the piston and the crankshaft and flywheel located below the piston;

FIG. 3 is a top view of the magnetically actuated reciprocating motor of FIG. 1 showing two permanent magnets that make up one embodiment of the reverse magnetic switching device;

FIG. 4 is a side view of the magnetically actuated reciprocating motor of FIG. 1 shown without the cylinder;

FIG. 5 is a cross-sectional front view of the magnetically actuated reciprocating motor of FIG. 4 taken through line 4-4 of FIG. 4;

FIG. 6 is a schematic showing the operation and orientation of the reverse magnetic switching mechanism and piston magnet through a complete cycle of operation of the magnetically actuated reciprocating motor configured according to the pivoting magnet embodiment of the present invention;

FIG. 7 is a schematic showing the operation and orientation of the reverse magnetic switching mechanism and piston magnet through a complete cycle of operation of the magnetically actuated reciprocating motor configured according to the rotating magnet embodiment of the present invention; and

FIG. 8 is a perspective view of a magnet fixture base supporting the permanent magnets utilized with the reverse magnetic switching device of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, the figures and description provided herein are directed to a single cylinder motor, however, those skilled in the art will readily understand that this is merely for purposes of simplifying the present disclosure and that the present invention is not so limited as multiple cylinders may be utilized for the present motor.

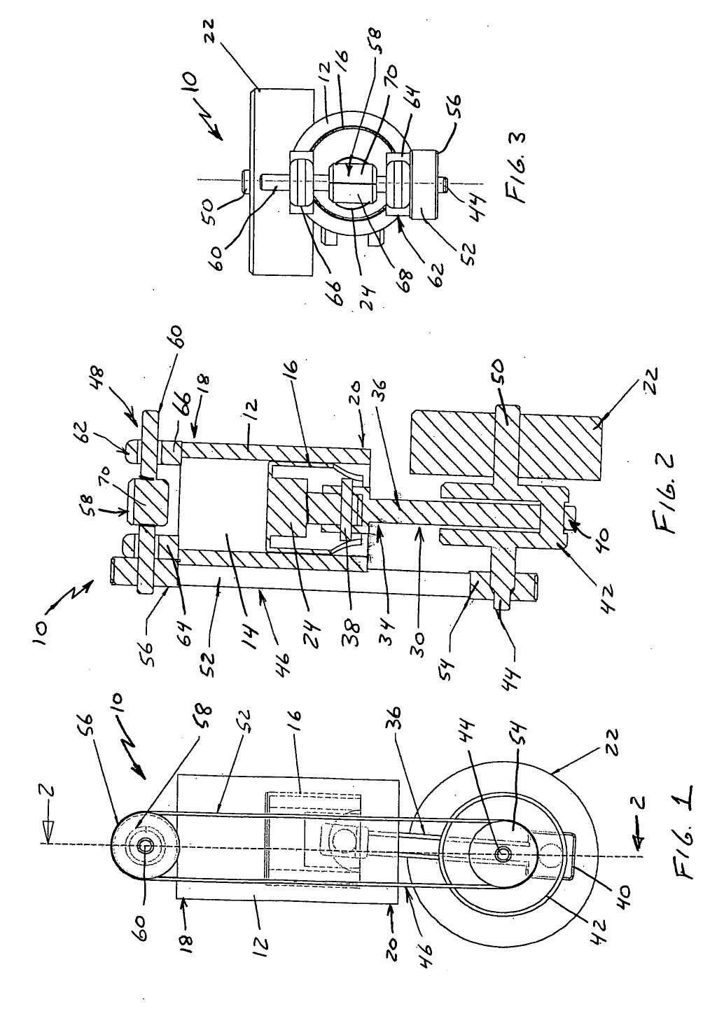

A magnetically actuated reciprocating motor that is manufactured out of the components and configured pursuant to a preferred embodiment of the present invention is shown generally as 10 in the figures. As best shown in FIGS. 1 through 3, motor 10 of the present invention generally has a cylinder 12 defining a chamber 14 with a piston 16 reciprocally disposed in chamber 14. As explained in more detail below, piston 16 is configured to reciprocally travel in chamber 14 between first end 18 and second end 20 of cylinder 12. Preferably, cylinder 12 and piston 16 are cooperatively configured such that the travel of piston 16 in chamber 14 is accomplished with a minimum amount of friction between the outer walls of piston 12 and the inner walls of chamber 14. Unlike for internal combustion engines, however, it is not necessary that cylinder 12 be configured to provide a sealed, enclosed chamber 14, as no combustion gases or other pressure inducing mechanism is utilized in motor 10 of the present invention to reciprocally move piston 16 between first end 18 and second end 20 of cylinder 12. Instead, as set forth below, motor 10 of the present invention utilizes the magnetic repelling and attracting force of permanent magnets to reciprocate piston 16 inside of cylinder 12 so as to operate a work object, such as flywheel 22, which can be connected to a pump, generator, vehicle or other mechanical device for accomplishing useful work. Due to the fact that motor 10 of the present invention does not utilize gasoline or other fossil fuel based energy sources for its operation, it does not require the use of these limited resources or generate the polluting exhaust that is a well known problem of internal combustion engines.

Although cylinder 12 of motor 10 can have a solid wall defining chamber 14 therein, such a configuration is not necessary and, in fact, is generally not preferred due primarily to various weight and manufacturing cost considerations. The purpose of cylinder 12 is to direct the movement of piston 16 in a generally linear direction so that as much force as possible is provided to operate work object 22. Because motor 10 of the present invention does not rely on the expansion of compressed gasses for the reciprocation of piston 16, cylinder 12 can be configured in many different ways to accomplish the objectives of the present invention. For instance, in one preferred embodiment cylinder 12 is configured in a generally cage or sleeve-like configuration. As described below, it is preferred that first 18 and second 20 ends of cylinder 12 are generally open to fully facilitate the operation of the magnetic forces and the movement of the apparatus driving work object 22. Because of the magnets and magnetic forces generated thereby, as set forth below, it is preferred that cylinder 12 be made out of nonferromagnetic material, such as aluminum, ceramic, carbon fiber, plastics, thermoplastic resins (such as nylon and polyfluroethylene), carbon composites and a variety of non-magnetic materials. As is readily understood by those skilled in the art, cylinder 12 can be configured in a variety of different sizes and shapes, including round, square, rectangle and oval cross-sections.

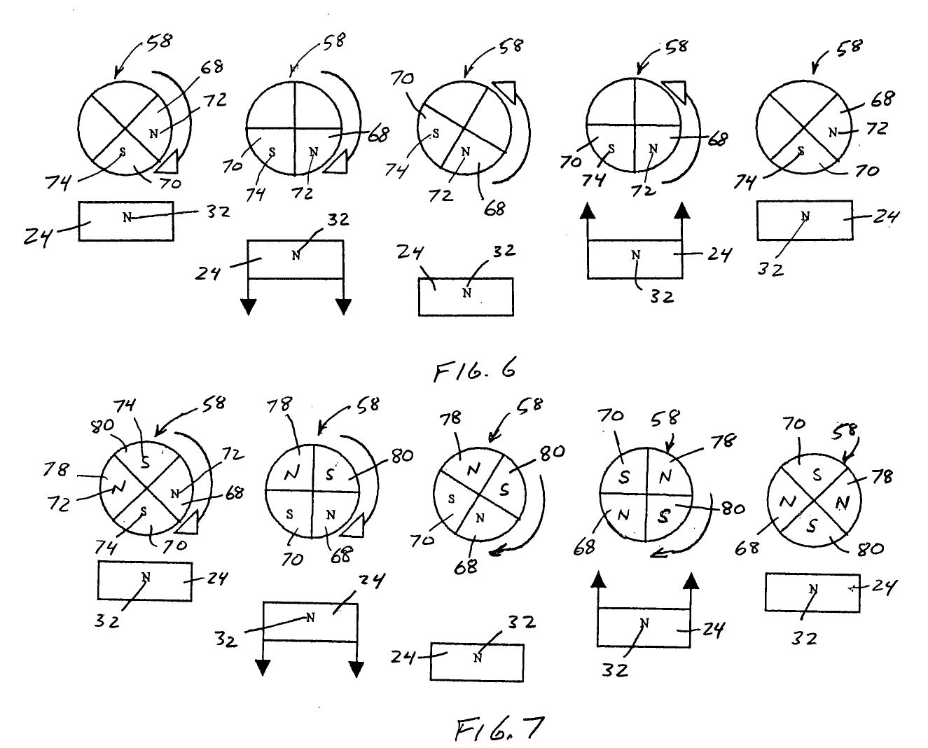

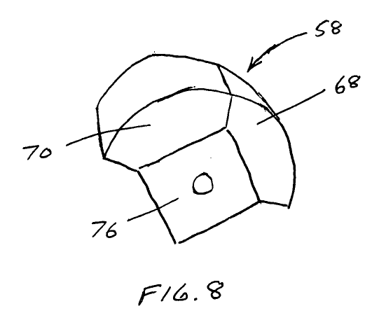

Piston 16 of the present invention should be sized and configured to be cooperatively received inside chamber 14 of cylinder 12 so as to reciprocate therein with a minimum amount of friction between it and cylinder 12. As set forth in more detail below, piston 16 is configured to be associated with piston magnet 24, either by attaching to or otherwise incorporating (i.e., integral with) piston magnet 24 generally at or near the first end 26 of piston 16, as best shown in FIGS. 2 and 5 (wherein FIG. 2 shows cylinder 12 in place and FIG. 5 is with cylinder 12 removed). In an alternative embodiment, piston magnet 24 is incorporated into piston 16 such that piston 16 is also piston magnet 24. In the preferred embodiment, the second end 28 of piston 16 attaches to a mechanism, shown generally as 30, for converting the linear reciprocating movement of piston 16 to rotate work object 22 and accomplish the desired work objectives. Because piston 16 of the preferred embodiment attaches to or otherwise carries piston magnet 24, piston 16 also needs to be made out of a nonferromagnetic material, such as those described above for cylinder 12. As best shown in FIGS. 2 and 5, piston 16 can define a support structure for magnet 24 that directs the polarity, such as north or south, of one end of magnet 24 outward (i.e., upward in the figures) from first end 26 of piston 16 toward first end 18 of cylinder 12. As shown in FIGS. 6 and 7, as further described below, in one embodiment the piston magnet polarity 32 is north or N. Although whether piston magnet polarity 32 is north or south is not specifically important, it is important that piston magnet polarity 32 be fixed in either a north or south orientation.

In the embodiment shown in the figures, the reciprocating converting mechanism 30 comprises a standard piston and crankshaft arrangement wherein the first end 34 of connecting rod 36 attaches to or near the second end 28 of piston 16 with pin 38 and the second end 40 of connecting rod 36 attaches to crankshaft 42. As best shown in FIGS. 2 and 5, crankshaft 42 has first output shaft 44 that connects to a controlling mechanism, shown generally as 46, for controlling the operation of the magnetic switching device 48 to reciprocate piston 16 in cylinder 12 and a second output shaft 50 that connects to and rotates work object 22. As will be readily familiar to those skilled in the art, appropriate bushings bearings, nuts and other devices must be utilized to secure work object 22 to second output shaft 50 such that the rotation of second output shaft 50, resulting from rotation of crankshaft 42 due to the reciprocating motion of connecting rod 36 connected to piston 16, rotates work object 22 as necessary to ensure function and useful life of motor 10 of the present invention. As also known to those skilled in the art, various other configurations are suitable for use as the converting mechanism 30 for converting the linear reciprocating motion of piston 16 in cylinder 12 to the desired rotary motion of work object 22.

As set forth above, first output shaft 44 of crankshaft 42, shown as generally opposite second output shaft 50 in FIGS. 2 and 5, connects to the mechanism 46 that is utilized to control the driving force necessary to obtain the reciprocating motion of piston 16. As set forth below, the interaction between the controlling mechanism 46 and the magnetic switching device 48 is what provides the magnetic switching that reverses the polarity directed towards piston magnet polarity 32 of piston magnet 24 at the first end 26 of piston 16. In the preferred embodiment of reciprocating motor 10 of the present invention, controlling mechanism 46 is a kinetic energy storage device that stores energy from the rotation of first output shaft 44 to pivot or rotate, as appropriate, magnetic switching device 48 to provide the reverse polarity operation necessary to reciprocate piston 16. Because controlling mechanism 46 connects directly to first output shaft 44 of crankshaft 42, no external energy source or prime mover is necessary to provide the polarity reversing that is essential to all magnetically actuated reciprocating motors, including reciprocating motor 10 of the present invention.

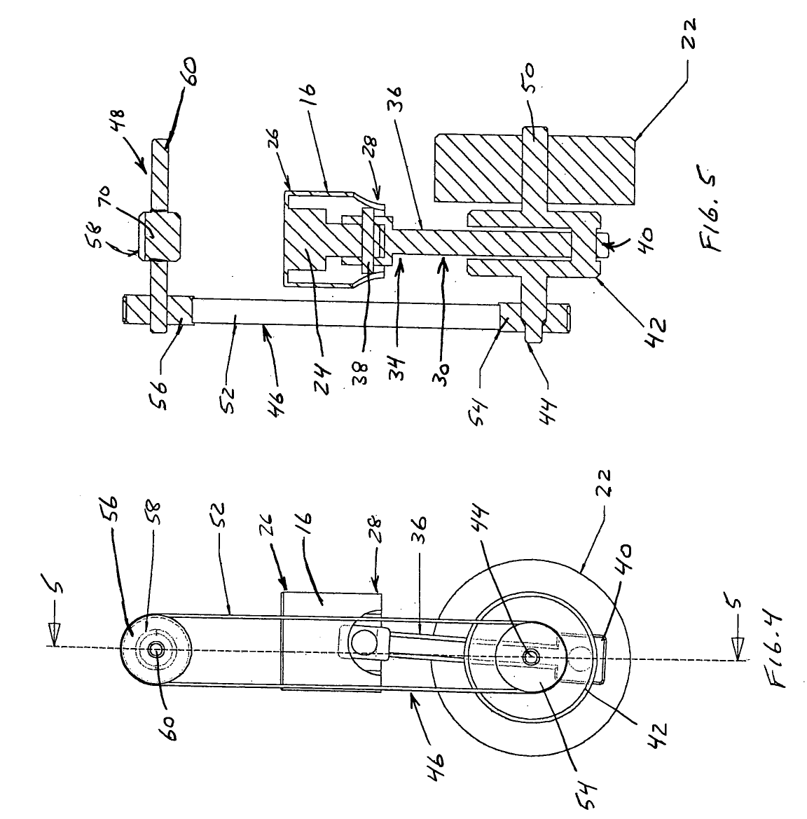

In the embodiment shown in FIGS. 1 through 5, controlling mechanism 46 comprises a belt member 52 that interconnects first pulley 54 and second pulley 56, as best shown in FIGS. 1 and 3. The use of belts and pulleys as a mechanism to transfer rotational motion from one object to another is well known to those skilled in the art. As will also be readily familiar to those skilled in the art, appropriate bushings bearings, nuts and other devices are necessary to ensure function and useful life of motor 10 of the present invention and secure first pulley 54 to first output shaft 44 so the rotation of first output shaft 44, resulting from rotation of crankshaft 42 from the reciprocating motion of connecting rod 36 connected to piston 16, will result in rotation of first pulley 54 and, by belt 52, second pulley 56. Second pulley 56 is configured with the proper gearing mechanism to operate magnetic switching device 48 as desired so as to result in the necessary movement of magnetic switching device 48, such as being geared to pivot magnetic switching device 48 for the operation schematic of FIG. 6 and geared to rotate magnetic switching device 48 for the operation schematic of FIG. 7, both of which are described in more detail below. As such, controlling mechanism 46 is configured to control or limit the amount of rotation of magnetic switching device 48 so as to correspond its operation to the reciprocating motion of piston 16, which is driven by magnetic switching device 48, so as to rotate crankshaft 42 and work object 50. As will be readily understood by those skilled in the art, controlling mechanism 46 described above can utilize a chain drive system instead of the belt drive system shown, with the chain drive system having appropriately geared-tooth pulleys 54 and 56 that are interconnected by a chain member or other connecting member, instead of belt 52. In addition, the belt or chain drive systems described above can be replaced with a gear drive system having a plurality of appropriately configured interconnecting gears from first output shaft 44 to magnetic switching device 48. In each of these configurations, the objective is to transfer the rotation of first output shaft 44 to provide the necessary motion and timing for magnetic switching device 48 so that it may magnetically direct the reciprocation of piston 16 in cylinder 12 in a manner that accomplishes the desired work objectives of motor 10 of the present invention.

In an alternative embodiment, the kinetic energy storage device of controlling mechanism 46 can be a spring-configured mechanism that stores energy in the form of a compressed spring, which results from the rotation of first output shaft 44. In this configuration, the belt and pulley system shown is removed and a spring is disposed between the first output shaft 44 of crankshaft 42 and the magnetic switching device 48. In another alternative embodiment of motor 10 of the present invention, the kinetic energy storage device of controlling mechanism 46 can be a fluid-based hydraulic compression system that stores energy in the compressed fluid, which results from the rotational movement of first output shaft 44. In this configuration, the compressed fluid is utilized to operate magnetic switching device 48. In another configuration, a solenoid can be utilized to operate magnetic switching device 48. In any of the above configurations, the storage of kinetic energy results from the rotation of crankshaft 42 that is achieved by the linear reciprocation of piston 16, which results from the operation of magnetic switching device 48 that is controlled by controlling mechanism 46.

In a preferred embodiment, magnetic switching device 48 comprises a magnetic fixture 58 that is attached to magnetic fixture shaft 60, as best shown in FIGS. 2, 5 and 8. One end of magnetic fixture shaft 60 is attached to second pulley 56 in a configuration that accomplishes the pivoting or rotating objectives of magnetic switching device 48 illustrated in FIGS. 6 and 7. As best shown in FIGS. 2 and 5, magnetic fixture shaft 60 of magnetic switching device 48 is rotatably supported above first end 18 of cylinder 12 by support structure 62, comprising first mounting bracket 64 and second mounting bracket 66, in a manner that disposes magnetic fixture 58 generally above piston magnet 24. First 64 and second 66 mounting brackets have appropriate bearings and/or bushings to permit rotation of magnetic fixture shaft 60 so as to pivot or rotate magnetic fixture 58 and reciprocally drive piston 16 in cylinder 12. As described in more detail below, the rotation of magnetic fixture 58, which results from the rotation of magnetic fixture shaft 60 by second pulley 56, alternatively directs a magnetic force to attract or repel piston magnet 24 and reciprocate piston 16. As shown in FIG. 8, magnetic fixture 58 comprises one or more fixture magnets, such as first fixture magnet 68 and second fixture magnet 70, that have a first fixture polarity 72 and a second fixture polarity 74 (as shown in FIGS. 6 and 7), respectively. In the embodiment shown, first fixture polarity 72 of first fixture magnet 68 corresponds to the piston magnet polarity 32 of piston magnet 24 (i.e., they are both north polarity) and second fixture polarity 74 of second fixture magnet 70 is the opposite polarity of piston magnet polarity 32 (i.e., it is south compared to the north of piston magnet 24). In the embodiment shown in FIG. 7, magnetic fixture 58 also includes a third fixture magnet 78 and a fourth fixture magnet 80. Third fixture magnet 78 has a polarity that is the same as first fixture polarity 72 and fourth fixture magnet 80 has a polarity that is the same as second fixture polarity 74. As magnetic fixture 58 rotates due to the action of controlling mechanism 46, it moves from first fixture polarity 72 to second fixture polarity 74 to reciprocate piston 16. In one configuration, shown in FIG. 8, first fixture magnet 68 and second fixture magnet 70 are securely mounted on magnetic fixture base 76, which is attached to magnetic fixture shaft 60. In such a configuration, magnetic fixture base 76 is preferably made of a nonferromagnetic material, such as those identified above. Whether the pivot action of FIG. 6 or the rotational action of FIG. 7 is utilized, magnetic fixture shaft 60, which is also preferably of a nonferromagnetic material, causes magnetic fixture 58 to pivot or rotate fixture magnets 68 and 70 so as to attract and repel piston magnet 24 by the alternating direction of corresponding or contrasting magnetic polarities of fixture magnets 68 and 70, as shown in FIGS. 6 and 7.

In the preferred embodiment of the present invention, piston magnet 24 and the fixture magnets 68, 70, 78 and 80 are rare earth magnets, which are known for their improved magnetic performance and longevity. Rare earth magnets such those known as samarium magnets (SmCo) and, more preferably, neodymium magnets (NdFeB) are known to provide the characteristics desired for the operation of reciprocating motor 10 of the present invention. Both these types of rare earth magnets are adaptable to being manufactured in a variety of different sizes and shapes, are known to be generally corrosion and oxidation resistant and more stable at higher temperatures.

As set forth in FIG. 6 for the embodiment where magnetic switching device 48 comprises a pivoting magnetic fixture 58, first fixture magnet 68 and second fixture magnet 70 are periodically rotated such that first fixture polarity 72 and second fixture polarity 74 are directed toward piston magnet polarity 32 of piston magnet 24. Beginning on the left, piston magnet 24 is shown at top dead center with second fixture magnet 70 directing second fixture polarity 74 towards piston magnet polarity 32 to attract piston magnet 24 and pull piston 16 towards the first end 18 of cylinder 12. As magnetic fixture 58 rotates, first fixture magnet 68 moves to begin directing first fixture polarity 72 towards piston magnet polarity 32 to repel piston magnet 24 and push piston 16 towards the second end 20 of cylinder 12. In the next illustration, first fixture magnet 68 is directing first fixture polarity 72 directly towards piston magnet polarity 32 and piston magnet 24 is at bottom dead center. As magnetic fixture 58 pivots back to its original position, second fixture magnet 70 moves to direct second fixture polarity 74 towards piston magnet polarity 32 and attract piston magnet 24, thereby moving piston 16 towards the first end 18 of cylinder 12. In the next illustration, piston magnet 24 is back at top dead center with second fixture magnet 70 directing second fixture polarity 74 directly towards piston magnet polarity 32. The operation of the embodiment shown in FIG. 7, where magnetic fixture 58 rotates instead of pivots, functions much the same as described above except that magnetic fixture 58 continues around to direct third fixture magnet 78, having first fixture polarity, and fourth fixture magnet 80, having second fixture polarity 74, towards piston magnet polarity 32 of piston magnet 24 to reciprocate piston 16 in cylinder 12.

In use, the periodic directing of first fixture polarity 72 and second fixture polarity 74 of magnetic switching device 48 towards piston magnet 24 at the first end 26 of piston 16 will periodically repel and attract piston 16 so as to reciprocate it inside cylinder 12. The reciprocation of piston 16 will, by way of connecting rod 36, rotatably drive crankshaft 42, which rotatably engages the controlling mechanism 46 at first output shaft 44 of crankshaft 42 and rotates work object 22 at second output shaft 50 of crankshaft 42. The operation of the controlling mechanism 46 controls the movement of magnetic switching device 48 so as to provide the pivoting or rotating motion necessary to obtain the polarity shifting that results in reciprocation of piston 16, through magnetic interaction between the fixture magnets (i.e., 68 and 70 or 68, 70, 78 and 80) and piston magnet 24. As such, the magnetically actuated reciprocating motor 10 of the present invention does not require any external power source or prime mover to provide the necessary polarity shifting for reciprocation of piston 16, thereby making the present motor more efficient and useful for obtaining a work output, such as to operate a pump, generator or vehicle. Use of reciprocating motor 10 of the present invention eliminates the energy demands and pollution associated with presently available reciprocating motors.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A magnetically actuated reciprocating motor, comprising:
a cylinder having a first end and a second end, said cylinder defining a chamber therein;
a piston reciprocally disposed in said chamber, said piston having a first end generally disposed toward said first end of said cylinder and a second end generally disposed toward said second end of said cylinder, said piston comprising a piston magnet having a piston magnet polarity directed outward of said first end of said piston toward said first end of said cylinder;
means for converting reciprocating movement of said piston to rotate a work object, said converting means comprising a first output shaft;
a magnetic switching device disposed above said first end of said cylinder, said magnetic switching device comprising a magnetic fixture having one or more fixture magnets, a first fixture polarity and a second fixture polarity, said first fixture polarity corresponding to said piston magnet polarity and said second fixture polarity opposite said piston magnet polarity; and
means interconnecting said first output shaft with said magnetic fixture of said magnetic switching device for controlling rotational movement and timing of said magnetic fixture to reciprocate said piston in said chamber,
wherein said piston is configured to move toward said second end of said cylinder when said first fixture polarity of said one or more fixture magnets is disposed toward said piston magnet and move toward said first end of said cylinder when said second fixture polarity of said one or more fixture magnets is disposed toward said piston magnet so as to rotate said first output shaft and said work object.

2. The reciprocating motor according to claim 1, wherein said piston magnet is attached to said first end of said piston.

3. The reciprocating motor according to claim 1, wherein said piston magnet is integral with said first end of said piston.

4. The reciprocating motor according to claim 1, wherein said converting means comprises a connecting rod having a first end and a second end and a crankshaft defining said first output shaft and a second output shaft, said first end of said connecting rod attached to said piston, said second end of said connecting rod attached to said crankshaft and configured to rotate said crankshaft, said second output shaft connected to said work object and configured to rotate said work object.

5. The reciprocating motor according to claim 1, wherein said controlling means is selected from the group comprising a belt drive, a chain drive and a gear drive, each of said belt drive and said chain drive having a first pulley connected to said first output shaft, a second pulley connected to said magnetic switching device and an elongated member interconnecting said first pulley and said second pulley, said chain drive having a plurality of interconnecting gears, including a first gear connected to said first output shaft and a second gear connected to said magnetic switching device.

6. The reciprocating motor according to claim 1, wherein said magnetic fixture comprises a first fixture magnet and a second fixture magnet, said first fixture magnet having said first fixture polarity disposed outward from said magnetic fixture and said second fixture magnet having said second fixture polarity disposed outward from said magnetic fixture, said controlling means adapted to periodically pivot said magnetic fixture between said first fixture magnet and said second fixture magnet so as to periodically attract and repel said piston magnet and reciprocate said piston.

7. The reciprocating motor according to claim 6, wherein said controlling means comprises a belt interconnecting a first pulley and a second pulley, said first pulley attached to said first output shaft and rotated thereby, said second pulley configured to pivot said magnetic fixture.

8. The reciprocating motor according to claim 1, wherein said magnetic fixture comprises a first fixture magnet, a second fixture magnet, a third fixture magnet and a fourth fixture magnet, each of said first fixture magnet and said third fixture magnet having said first fixture polarity disposed outward from said magnetic fixture, each of said second fixture magnet and said fourth fixture magnet having said second fixture polarity disposed outward from said magnetic fixture, said controlling means adapted to rotate said magnetic fixture so as to periodically direct said first fixture polarity and said second fixture polarity toward said piston magnet so as to periodically attract and repel said piston magnet and reciprocate said piston.

9. The reciprocating motor according to claim 8, wherein said controlling means comprises a belt interconnecting a first pulley and a second pulley, said first pulley attached to said first output shaft and rotated thereby, said second pulley configured to rotate said magnetic fixture.

10. The reciprocating motor according to claim 1 further comprising a support structure disposing said one or more fixture magnets of said magnetic switching device above said first end of said cylinder, said magnetic fixture of said magnetic switching device attached to a magnetic fixture shaft, said magnetic fixture shaft rotatably attached to said support structure.

11. A magnetically actuated reciprocating motor, comprising:
a cylinder having a first end and a second end, said cylinder defining a chamber therein;
a piston reciprocally disposed in said chamber, said piston having a first end and a second end;
a piston magnet at said first end of said piston, said piston magnet having a piston magnet polarity directed outward of said first end of said piston;
means for converting reciprocating movement of said piston to rotate a work object, said converting means comprising a first output shaft;
a magnetic switching device comprising a magnetic fixture attached to a magnetic fixture shaft, said magnetic fixture comprising one or more fixture magnets having a first fixture polarity and a second fixture polarity, said first fixture polarity corresponding to said piston magnet polarity and said second fixture polarity opposite said piston magnet polarity;
a support structure disposing said one or more fixture magnets of said magnetic switching device above said first end of said cylinder, said magnetic fixture shaft rotatably attached to said support structure; and
means interconnecting said first output shaft with said magnetic fixture shaft of said magnetic switching device for controlling rotational movement and timing of said magnetic fixture to reciprocate said piston in said chamber,
wherein said piston is configured to move toward said second end of said cylinder when said first fixture polarity of said one or more fixture magnets is disposed toward said piston magnet and move toward said first end of said cylinder when said second fixture polarity of said one or more fixture magnets is disposed toward said piston magnet so as to rotate said first output shaft and said work object.

12. The reciprocating motor according to claim 11, wherein said controlling means is selected from the group comprising a belt drive, a chain drive and a gear drive, each of said belt drive and said chain drive having a first pulley connected to said first output shaft, a second pulley connected to said magnetic switching device and an elongated member interconnecting said first pulley and said second pulley, said chain drive having a plurality of interconnecting gears, including a first gear connected to said first output shaft and a second gear connected to said magnetic switching device.

13. The reciprocating motor according to claim 11, wherein said magnetic fixture comprises a first fixture magnet and a second fixture magnet, said first fixture magnet having said first fixture polarity disposed outward from said magnetic fixture and said second fixture magnet having said second fixture polarity disposed outward from said magnetic fixture, said controlling means adapted to periodically pivot said magnetic fixture between said first fixture magnet and said second fixture magnet so as to periodically attract and repel said piston magnet and reciprocate said piston.

14. The reciprocating motor according to claim 13, wherein said controlling means comprises a belt interconnecting a first pulley and a second pulley, said first pulley attached to said first output shaft and rotated thereby, said second pulley attached to said magnetic fixture shaft and configured to pivot said magnetic fixture shaft.

15. The reciprocating motor according to claim 11, wherein said magnetic fixture comprises a first fixture magnet, a second fixture magnet, a third fixture magnet and a fourth fixture magnet, each of said first fixture magnet and said third fixture magnet having said first fixture polarity disposed outward from said magnetic fixture, each of said second fixture magnet and said fourth fixture magnet having said second fixture polarity disposed outward from said magnetic fixture, said controlling means adapted to rotate said magnetic fixture so as to periodically direct said first fixture polarity and said second fixture polarity toward said piston magnet so as to periodically attract and repel said piston magnet and reciprocate said piston.

16. The reciprocating motor according to claim 15, wherein said controlling means comprises a belt interconnecting a first pulley and a second pulley, said first pulley attached to said first output shaft and rotated thereby, said second pulley attached to said magnetic fixture shaft and configured to rotate said magnetic fixture shaft.

17. The reciprocating motor according to claim 11, wherein said cylinder and said piston are made from or coated with a nonferromagnetic material.

18. The reciprocating motor according to claim 11, wherein said support structure abuts said first end of said cylinder.

19. A magnetically actuated reciprocating motor, comprising:
a cylinder having a first end and a second end, said cylinder defining a chamber therein;
a piston reciprocally disposed in said chamber, said piston having a first end and a second end;
a piston magnet at said first end of said piston, said piston magnet having a piston magnet polarity directed outward of said first end of said piston;
means for converting reciprocating movement of said piston to rotate a work object, said converting means comprising a first output shaft;
a magnetic switching device comprising a magnetic fixture attached to a magnetic fixture shaft, said magnetic fixture comprising at least a first fixture magnet and a second fixture magnet, said first fixture having a first fixture polarity and said second fixture magnet having a second fixture polarity, said first fixture polarity corresponding to said piston magnet polarity and said second fixture polarity opposite said piston magnet polarity;
a support structure disposing said first fixture magnet and said second fixture magnet of said magnetic switching device above said first end of said cylinder, said magnetic fixture shaft rotatably attached to said support structure; and
a first pulley at said first output shaft;
a second pulley attached to said magnetic switching device and adapted to control the rotational movement and timing of said magnetic fixture so as to reciprocate said piston in said chamber; and
a connecting member interconnecting said first pulley and said second pulley,
wherein said piston is configured to move toward said second end of said cylinder when said first fixture polarity of said first fixture magnet is disposed toward said piston magnet and move toward said first end of said cylinder when said second fixture polarity of said second fixture magnet is disposed toward said piston magnet so as to rotate said first output shaft and said work object.

20. The reciprocating motor according to claim 19, wherein said second pulley is adapted to pivot said magnetic fixture.
